(19) United States
(12) Patent Application Publication
(10) Pub. No.: US 2013/0212150 A1
(43) Pub. Date: Aug. 15, 2013

(54) CONTENT DATA PROCESSING APPARATUS AND CONTENT DATA PROCESSING METHOD

(71) Applicant: PANASONIC CORPORATION, (US)

(72) Inventors: Hideto KOBAYASHI, Osaka (JP); Yusuke KAMOTANI, Osaka (JP)

(73) Assignee: PANASONIC CORPORATION, Osaka (JP)

(21) Appl. No.: 13/766,295

(22) Filed: Feb. 13, 2013

(30) Foreign Application Priority Data
Feb. 15, 2012 (JP) 2012-030273

(51) Int. Cl. H04L 29/08

(52) U.S. Cl. CPC H04L 67/02
USPC 709/201

(57) ABSTRACT

A content data processing apparatus that performs processing on a content data including an additional data, the content data processing apparatus includes: a processor that: (i) acquires the content data; (ii) extracts the additional data included in the acquired content data, rewrites a processing-target information which is at least a part of predetermined personal information contained in the additional data, and generates, from the additional data, a rewritten data having a data amount which is the same with a data amount of the additional data, the predetermined personal information being defined based on a predetermined condition; and (iii) generates a processed content data in which the additional data included in the content data is rewritten to the rewritten data.

### CROSS REFERENCE TO RELATED APPLICATION

The present application is based on and claims priority of Japanese Patent Application No. 2012-030273 filed on Feb. 15, 2012. The entire disclosure of the above-identified application, including the specification, drawings and claims is incorporated herein by reference in its entirety.

### FIELD

The present disclosure relates to a content data processing apparatus that processes additional data included in content data.

### BACKGROUND

An image sharing system has been known in which an image (content data) shot by an imaging device, such as a digital camera, can be shared with other persons. Patent Literature 1 (PTL 1) discloses, for example, a system in which an image shot by a digital camera can be shared. A user shoots, using a camera-equipped communication device, a code that indicates an external server in which the image is stored, and accesses the external server in accordance with the shot code, so as to acquire the image.

### CITATION LIST

### Patent Literature

[PTL 1] Japanese unexamined patent application publication No. 2008-236159

### SUMMARY

### Technical Problem

When content data is shared in a system including the aforementioned image-sharing system, a header (additional data) of the content data may be processed. For the occasion, some processing methods may affect on a quality (image quality, and so on) of a content (a part except the header) of the content data.

An object of the present disclosure is to provide a content data processing apparatus that can process additional data included in the content data with minimizing effect on the quality of the content.

### Solution to Problem

A content data processing apparatus, according to the present disclosure, performs processing on a content data including an additional data, and the content data processing apparatus includes: a processor that: (i) acquires the content data; (ii) extracts the additional data included in the acquired content data, rewrites a processing-target information which is at least a part of predetermined personal information contained in the additional data, and generates, from the additional data, a rewritten data having a data amount which is the same with a data amount of the additional data, the predetermined personal information being defined based on a predetermined condition; and (iii) generates a processed content data in which the additional data included in the content data is rewritten to the rewritten data.

### Advantageous Effects

With a content data processing apparatus according to the present disclosure, additional data included in content data can be processed with minimizing effect on a quality of a content.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a conceptual diagram for illustrating an example of an image sharing service.

FIG. 2 is a block diagram that shows an electrical configuration of a personal computer (PC).

FIG. 3 is a block diagram that shows a functional configuration of a controller.

FIG. 4 is a block diagram that shows an electrical configuration of a server.

FIG. 5 is a flowchart that shows an outline of an operation of uploading image data on a server of the PC

FIG. 6 is a flowchart that shows a detailed example of the operation of uploading the image data on the server of the PC

FIG. 7 is a diagram that schematically shows an image data.

FIG. 8 is a conceptual diagram that shows an example of additional data in an exchangeable image file format (EXIF).

FIG. 9 is a flowchart that shows an operation of rewriting information of a specified IFD in the EXIF format to invalid data.

FIG. 10 is a flowchart that shows another operation of rewriting information of a specified IFD in the EXIF format to invalid data.

FIG. 11 is a conceptual diagram that shows rewritten data resulted from processing the additional data shown in FIG. 8.

### DESCRIPTION OF EMBODIMENT

### Embodiment 1

Hereinafter, an embodiment is described in detail, arbitrarily referring to the drawings. However, detailed description beyond necessity may be omitted. For example, detailed description for well-known matter or duplicated description for a configuration substantially the same with the one previously described may be omitted. This is to avoid the following description from being unnecessarily redundant, and helps a person skilled in the art to easily comprehend the description.

It should be noted that the inventors provide the attached drawings and the following description for adequate comprehension by a person skilled in the art. It is not intended that the drawings and the description limit a subject matter of the claims.

### Embodiment

When a person sends, using an electronic device, his/her image data (content data) to another electronic device, some processing may be performed on the image data to be sent. For the occasion, it is beneficial to perform the processing with minimizing the affect on the image quality.

In the embodiment, a personal computer (PC) is described which is an example of a content data processing apparatus capable of performing the processing on image data with minimizing the effect on an image quality.

In the embodiment, an example is described in which image data is processed in a PC, and the processed image data is sent from the PC to a server that provides an image-sharing service.

[1-1. Image Sharing Service]

First, an image sharing service is described.

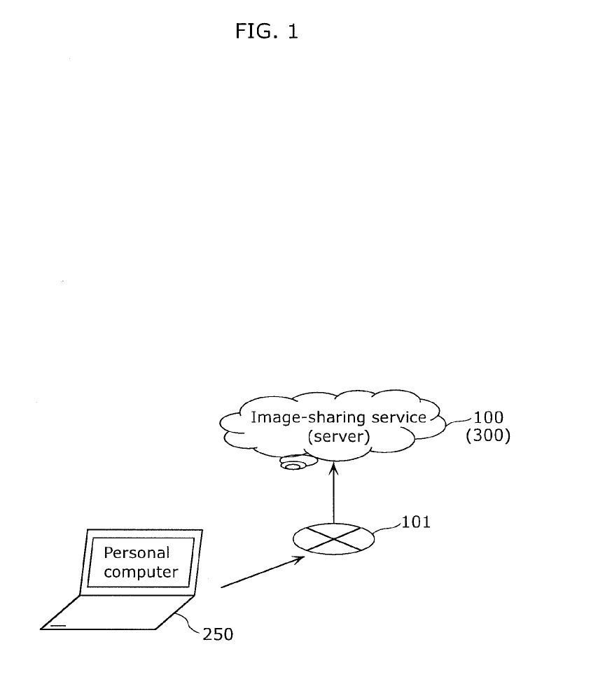

FIG. 1 is a conceptual diagram for illustrating an example of the image sharing service.

A PC 250 includes a communication unit and can connect an Internet network 101 via a wired local area network (LAN) or a wireless LAN. The Internet network 101 is connected to a server 300 placed outside for providing an image-sharing service 100.

The PC 250 uploads image data on the server 300, using the communication unit. The image data uploaded on the server 300 can be browsed (accessed) by other users who use the image-sharing service.

The image data includes personal information, such as GPS location information indicating a place where an image of the image data is shot, a name of a person who shot the image. In view of the above, a user who uploads image data can restrict access by other users to the image data uploaded by the user.

However, additional data, such as personal information, included in the image data may be mistakenly released due to incorrect setting of the browsing-restriction. To cope with the above, the PC 250 automatically performs processing on the additional data when the image data is uploaded. This allows users to use the image-sharing service 100 without carelessly releasing the personal information.

As described later, the processing by the PC 250 is performed in such a manner that a data amount (hereinafter, it may also be referred to as “data capacity” or “data size”) does not vary between image data in which the processing is performed and image data in which the processing is not performed. In the following description, the PC 250 and the image-sharing service 100 are described in relation to a configuration and an operation.

[1-2. Configuration]

Hereinafter, the PC 250 and the image-sharing service 100 are described in relation to a configuration.

[1-2-1. Configuration of Personal Computer]

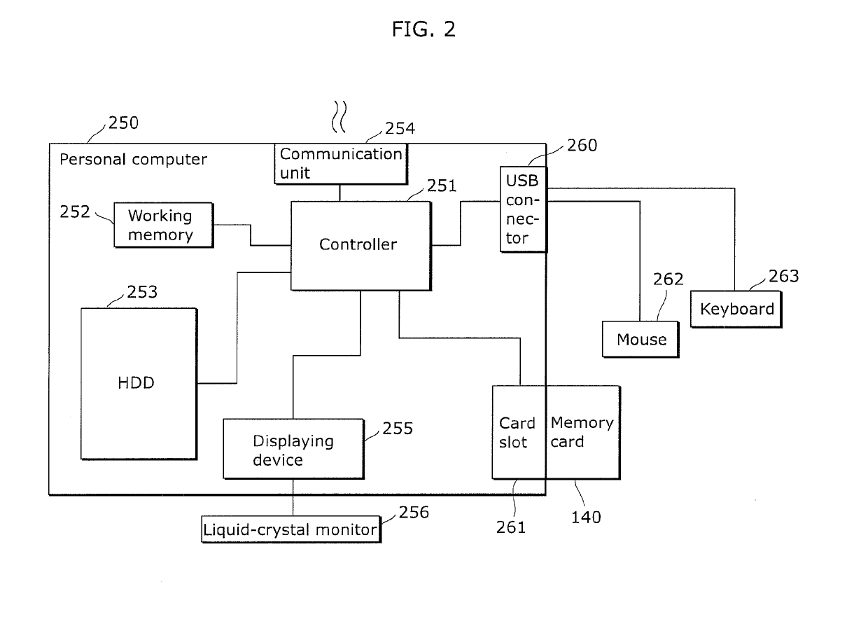

FIG. 2 is a block diagram that shows an electrical configuration of the PC 250.

The PC 250 includes a controller 251, a working memory 252, a hard disc drive (HDD) 253, a communication unit 254, a displaying device 255, a universal serial bus (USB) connector 260, and a card slot 261. The PC 250 is also connected to a memory card 140, a liquid-crystal monitor 256, a mouse 262, and a keyboard 263, which work as peripheral units of the PC 250.

The controller 251 is a processing unit for performing the processing in the PC 250. The controller 251 is electrically connected to the respective working memory 252, HDD 253, communication unit 254, liquid-crystal monitor 256, USB connector 260, card slot 261, mouse 262, and keyboard 263. The controller 251 receives, via the USB connector 260, an instruction from a user using the mouse 262 and the keyboard 263. The controller 251 can read out image data stored in the HDD 253 and the memory card 140 inserted in the card slot 261. In addition, the controller 251 totally controls a power-supply system through which power is supplied to the respective units in the PC 250.

The working memory 252 is a memory in which information necessary for the controller 251 to perform the processing is temporarily stored. The working memory 252 is, for example, a dynamic random access memory (DRAM) or a ferrodielectric memory.

The HD 253 is a disc drive having a large capacity for various data such as image data to be stored. As described above, various data stored in the HDD 253 can be arbitrarily read out by the controller 251.

The mouse 262 is a pointing device for receiving an operation by a user. The keyboard 263 is a keyboard device for inputting a character by a user.

The USB connector 260 is an interface connected, via a USB cable, to a USB connector of a device except the PC 250. The controller 251 can send and receive information with other devices via the USB connector 260 and the USB cable. The USB connector 260 is connected to the mouse 262, the keyboard 263, and so on.

The displaying device 255 is a device for imaging screen information calculated by the controller 251, and for transmitting the screen information to the liquid-crystal monitor 256.

The liquid-crystal monitor 256 is a displaying device for displaying a screen indicated by the screen information specified by the displaying device 255.

The communication unit 254 sends the image data received from the controller 251 to other devices via an Internet network. The communication unit 254 also receives the image data from other devices. The communication unit 254 performs communication, using a wired LAN and a wireless LAN, for example.

The memory card 140 is inserted in the card slot 261. The card slot 261 and the inserted memory card 140 are electrically and mechanically connected to each other. As described above, the controller 251 can read out the image data stored in the memory card 140. The card slot 261 may have a function for controlling writing in and reading out data with respect to the memory card 140.

[1-2-2. Configuration of Controller]

Next, a functional configuration of the controller 251 is described in detail.

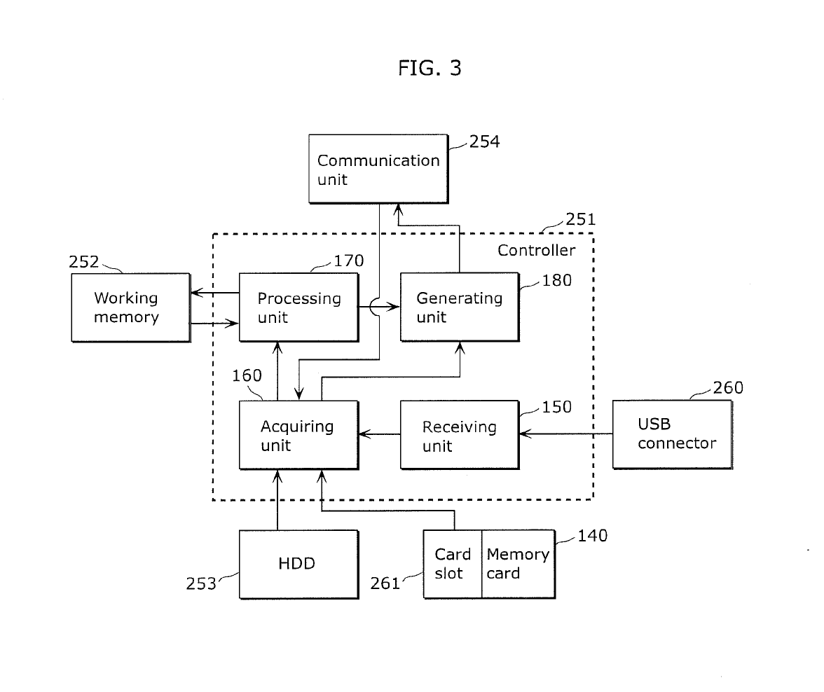

FIG. 3 is a block diagram that shows a functional configuration of the controller 251.

The controller 251 includes a receiving unit 150, an acquiring unit 160, a processing unit 170, and a generating unit 180.

The receiving unit 150 receives an instruction inputted by a user using the mouse 262 or the keyboard 263.

The acquiring unit 160 acquires image data based on the instruction received by the receiving unit 150. To be specific, the acquiring unit 160 acquires image data stored in the HDD 253 or the memory card 140. The acquiring unit 160 may acquire image data from other devices via the communication unit 254.

The processing unit 170 extracts the additional data included in the image data acquired by the acquiring unit 160, rewrites at least a part of predetermined personal information contained in the additional data (hereinafter, it may be referred to as processing-target information or rewritten-target information), and generates rewritten data having a data amount which is the same with a data amount of the additional data. Here, the predetermined personal information is defined based on a condition (predetermined condition) in relation to a releasable range. A method for rewriting data is described later in detail.

It should be noted that the personal information means information having a possibility to identify a person who shot an image of the image data or a person who was shot in the image. To be specific, the personal information includes, for example, location information indicating a place where the image was shot, time-and-date information indicating year, month, day, and time when the image is shot, photographer information indicating a person who shot the image, object information indicating an object reconstructed from the image data, and so on.

The generating unit 180 generates processed image data (processed content data) including the additional data which has been rewritten to rewritten data, in the image data. In the specification, “generation” by the generating unit 180 means the generation performed in the content data processing apparatus, and may also mean generation in other apparatuses consequently. An example of the above includes a case when the processed image data is uploaded on a server which will be described later (when the processed image data is generated in an HDD in a server).

[1-2-3. Configuration of Server Proving Image-Sharing Service]

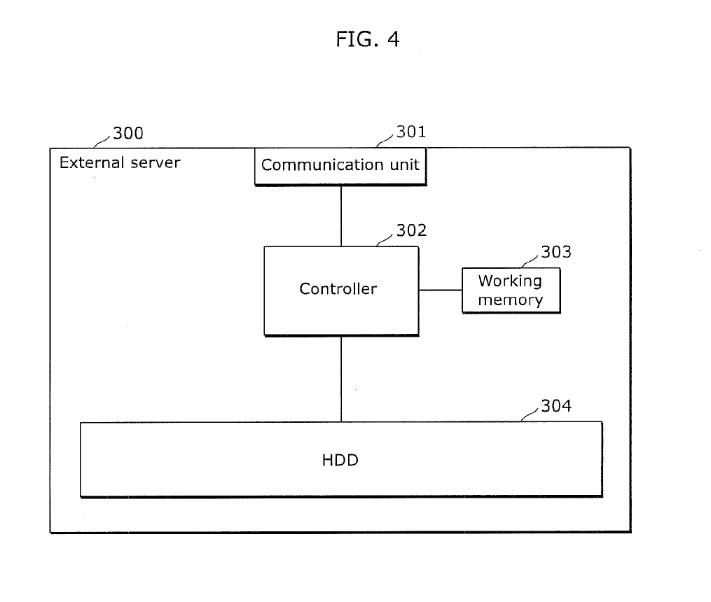

Subsequently, a configuration of the server 300 that provides the image-sharing service 100 is described, referring to FIG. 4.

FIG. 4 is a block diagram that shows an electrical configuration of the server 300.

The server 300 includes a controller 302, a working memory 303, an HDD 304, and a communication unit 301.

The controller 302 is a processing unit for performing processing in the server 300. The controller 302 is electrically connected to the respective working memory 303, HDD 304, and communication unit 301. The controller 302 can read out image data stored in the HDD 304.

The working memory 303 is a memory in which information necessary for the controller 302 to perform the processing is temporarily stored.

The HDD 304 is a disc drive having a large capacity for various data including image data to be stored. As described above, the various data stored in the HDD 304 can be arbitrarily read out by the controller 302. The image data received by the communication unit 301 from the PC 250 and the like is also stored in the HDD 304.

The communication unit 301 can receive image data from other devices via an Internet network. The image data received by the communication unit 301 is stored in the HDD 304 by the controller 302. The communication unit 301 performs communication, using a wired LAN and a wireless LAN.

The server 300 is an information processing apparatus that provides the image-sharing service 100.

[1-2-4. Configuration of Image-Sharing Service]

The image-sharing service 100 has a configuration described below. Hereinafter, description proceeds under the condition that a user who uploads image data using the PC 250 is a first user, and another user who browses the image data using the image-sharing service 100 is a second user.

When the first user instructs the PC 250 to upload an image via the image-sharing service 100, the image data is sent from the PC 250 to the server 300. The server 300 receives the image data, using the communication unit 301. The image data received by the communication unit 301 is stored, by the controller 302, in an area (first area) in the HDD 304, which is previously allocated to the first user.

Here, the first user can set whether or not the other users can browse the image data stored in the first area. If the first user configures the setting to allow the second user to browse the image data, the second user can freely browse the image data stored in the first area via the image-sharing service 100.

Specifically, the first user can set, for the image data, a range (hereinafter, a “releasable range”) that defines other users who can browse the image data via the image-sharing service 100. In other words, the first user can restrict access from other users to the image data uploaded by the first user, by setting a releasable range.

The releasable range is set in such a manner that no restriction on the access is set and public access is allowed, or access only by specified friends or acquaintances is allowed. The releasable range can also be set in such a manner that access by only acquaintances who belong to a specified category (a place of work, a graduated school, a community, and so on) is allowed.

[1-3 Operation]

Next, an operation of uploading image data by the PC 250 via the image-sharing service 100 is described.

[1-3-1. Outline of Upload Operation]

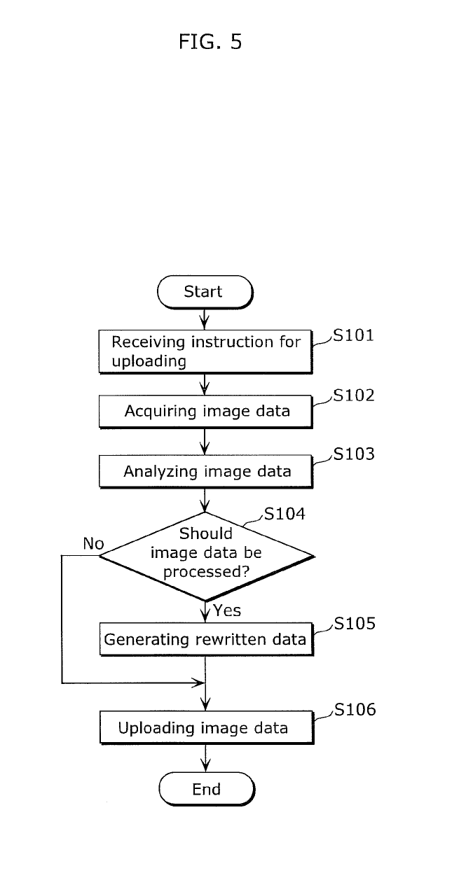

FIG. 5 is a flowchart that shows an outline of an operation of uploading image data by the PC 250 on the server 300.

The receiving unit 150 receives an instruction for uploading image data from a user (Step S101).

The acquiring unit 160 acquires the image data to be uploaded from the HDD 253 and the like (Step S102).

The processing unit 170 analyzes the image data to be uploaded, which has been acquired by the acquiring unit 160 (Step S103). To be specific, the processing unit 170 primarily analyzes a header (a part where metadata is recorded) of the image data in which administration information and the like with respect to the image is stored. To be more specific, the processing unit 170 analyzes whether or not specified personal information exists in the additional data that is a rewritable part in the header. The personal information includes GPS location information indicating a place where the image was shot, and a name of a person who shot the image.

Subsequently, the processing unit 170 determines whether or not the processing on the image data is needed based on the result of the analysis on the image data and a previously set releasable range (predetermined condition) (Step S104). Specifically, the processing unit 170 determines rewriting of the additional data is needed when the personal information exists in the additional data and the releasable range is set as a public view which has no restriction on the access, for example. The processing unit 170 also determines the rewriting of the additional data is not needed when no personal information exists in the additional data, or when the releasable range is set only to specified friends and acquaintances even if the personal information exists in the additional data. In the embodiment, the releasable range (the number of the second users who can browse the image data) and an item (location information, a personal name, and so on) of the rewritten-target personal information in view of the releasable range are previously associated with each other.

When determining the processing on the image data is needed (Yes in step S104), the processing unit 170 generates, from the additional data, rewritten data in which processing-target information in the additional data is rewritten, and temporarily stores the rewritten data in the HDD 253 (Step S105). Here, the additional data and the rewritten data are equal to each other in a data amount.

Subsequently, the generating unit 180 controls the communication unit 254 to upload, on the server 300, processed image data including the additional data in the unprocessed image data which has been rewritten to the rewritten data (Step S107). To be specific, the generating unit 180 controls the communication unit 254 to read out the rewritten data instead of the additional data when the communication unit 254 reads out the additional data upon uploading the image data, so as to generate the processed image data in the HDD 304 in the server 300.

When the processing unit 170 determines that the processing on the image data is not needed (No in Step S104), the generating unit 180 controls the communication unit 254 to read out, from the HDD 253, the image data specified by the user, as it is, and uploads the read-out image data in the server 300 (Step S107).

The above is an outline of the operation of uploading the image data on the server 300 by the PC 250 according to the embodiment.

[1-3-2. Details of Upload Operation]

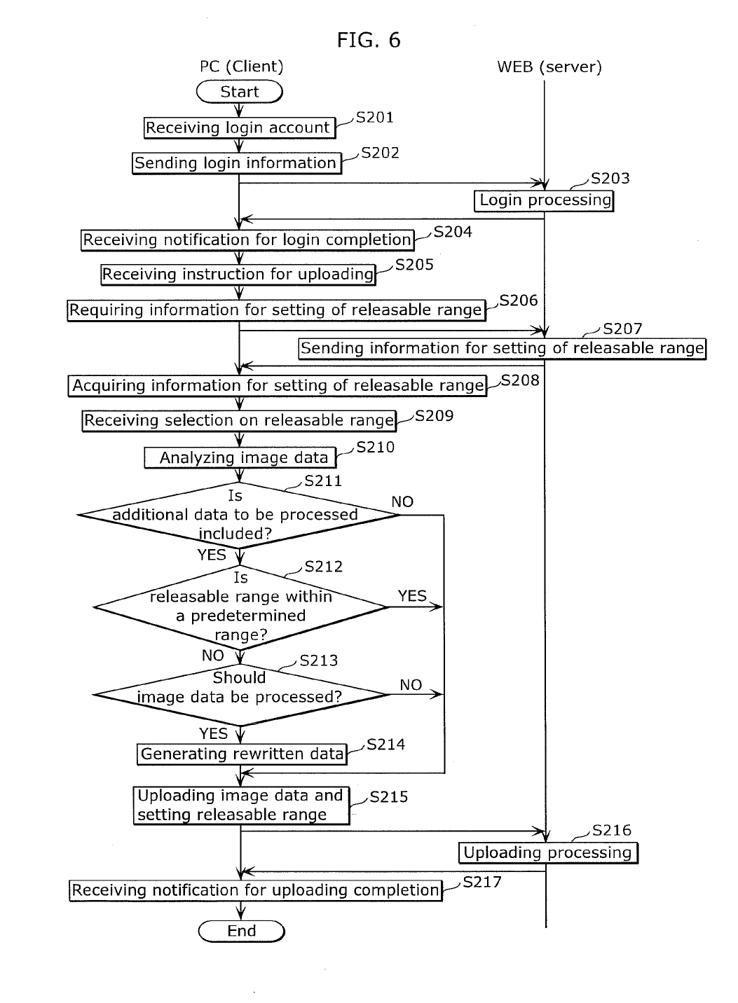

Next, an example of an operation of uploading image data by the PC 250 via the image-sharing service 100 is described in detail, referring to FIG. 6.

FIG. 6 is a flowchart that shows, in detail, an example of the operation of uploading image data by the PC 250 on the server 300.

First, the receiving unit 150 receives a login account for accessing the image-sharing service 100, which is inputted by the first user using the keyboard 263 and the like (Step S201). The controller 251 in the PC 250 sends, to the server 300, information in relation to the login account inputted by the user, using the communication unit 254 (Step S02).

When acquiring the information in relation to the login account sent by the controller 251 in the PC 250, the controller 302 in the sever 300 performs login processing and sends, to the PC 250, a response including information in relation to completion of the login (Step S203). The controller 251 receives the response via the communication unit 254 (Step S204).

Subsequently, the receiving unit 150 receives an instruction for uploading image data inputted by the user via the image-sharing service 100 (Step S205).

First, the controller 251 in the PC 250 requires information for setting of a releasable range (releasable-range setting information), which is to be provided by the image-sharing service 100 (Step S206).

When acquiring the request for information for the setting in relation to the releasable range from the controller 251 in the PC 250, the controller 302 in the server 300 sends the releasable-range setting information to the controller 251 in the PC 250 (Step S207). The controller 251 in the PC 250 receives the information (Step S208).

The releasable-range setting information is information that indicates what kind of a releasable range can be set in the image-sharing service 100. As described above, the releasable-range setting information includes a publically-acceptable range in which no particular access restriction is set, a range in which only specified friends and acquaintances are allowed to make access, a range in which only acquaintances who belong to a specified category (a working place, a graduated school, a community, and so on) are allowed to make access.

Here, the receiving unit 150 receives an input, from the first user, for selecting the releasable range based on the setting of the releasable range sent from the image-sharing service 100 (server 300) (Step S209).

The processing unit 170 analyzes whether or not specified personal information and the like exists in the header of the image data specified by the user in Step S205 (Step S210). As a result of the image-data analysis in Step S210, the processing unit 170 determines whether or not processing-target additional data is included in the image data (Step S211). Here, the processing-target additional data is additional data containing information for identifying personal information, such as GPS location information for a place where the image was shot, a personal name, and so on.

When the processing-target additional data is not included in the image data (No in Step S211), the processing unit 170 does not generate the rewritten data. In this case, the generating unit 180 controls the communication unit 254 to upload, on the server 300, the image data which is not processed (Step S215). At this time, the communication unit 254 sends, to the server 300, the releasable-range setting information that indicates the releasable range selected along with the image data by the user in Step S209.

Subsequently, the controller 302 in the server 300 performs upload processing for the image data uploaded from the PC 250 (Step S216). To be specific, the controller 302 in the server 300 records, in the HDD 304, the image data uploaded by the PC 250, and restricts an access so that only other users can make the access, who are specified by the releasable range indicated in the releasable-range setting information.

Upon completion of the record of the image data, the controller 302 notifies the PC 250 of the completion of the upload. The controller 251 receives the upload-completion notification via the communication unit 254 (Step S217).

Consideration is given to the contrary case, i.e., when the image data includes the processing-target additional data as a result of the image-data analysis in Step S210 (Yes in Step S211). Only when the releasable range selected by the user in Step S209 is within a predetermined range (Yes in Step S212), the processing unit 170 does not perform processing on the image data and the generating unit 180 uploads the image data which is not processed (Steps S215 to S217). The releasable range within the predetermined range means that users who belong to the releasable range consist only of the user himself/herself and other users allowed to browse the personal information.

However, when the releasable range selected by the user is a releasable range in which no particular restriction is set on accessing to the uploaded image data and which is a publically released range (No in Step S212), the controller 251 confirms to the user, whether or not the image data should be processed (Step S213). This is because that if the image data is publically released, the unspecified number of public users using the image-sharing service 100 may analyze a data content of the uploaded image data, outside the user's consciousness. Specifically, the controller 251 displays, on the liquid-crystal monitor 256, for example, a message and the like which confirms a user as to whether or not the image data should be processed. This allows the user to select whether or not a part of the image data containing the specified personal information, such GPS location information and a personal name, should be processed.

When the user determines that the image data need not be processed (No in Step S213), the processing unit 170 does not generate the rewritten data, and the generating unit 180 controls the communication unit 254 to upload the image data which is not processed (Steps S215 to S217). On the other hand, when the user determines the image data should be processed (Yes in Step S213), the processing unit 170 generates the rewritten data (Step S214). The generating unit 180 controls the communication unit 254 to upload, on the server 300, the image data which has been processed (Step S215). At this time, the communication unit 254 sends, to the server 300, the releasable-range setting information that indicates the releasable range selected along with the image data by the user in Step S208.

The controller 302 in the server 300 records the processed image data in the HDD 304, and restricts on the access so that only the other users specified in the releasable range shown in the releasable-range setting information can make the access (Step S216). Upon completion of the record of the image data, the controller 302 notifies the PC 250 of the completion of the upload. The controller 251 receives the upload-completion notification via the communication unit 254 (Step S217).

The processes described with reference to FIG. 6 allow the user to easily rewrite the personal information in the additional data in the image data.

[1-4. Method for Generating Rewritten Data]

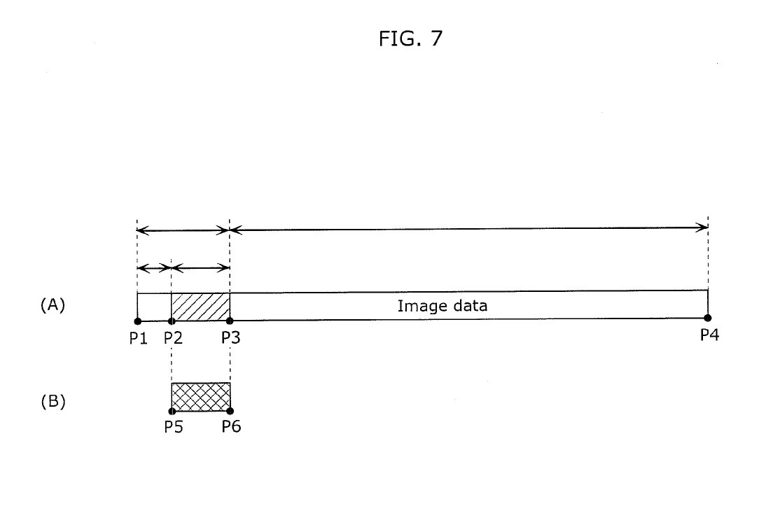

Subsequently, an outline is described with respect to a method for generating rewritten data, which is to be performed by the processing unit 170, referring to FIG. 7. FIG. 7 is a diagram that schematically shows image data.

FIG. 7(A) shows a data amount (size of the data) of image data which is not yet processed. Specifically, an area defined by P1 and P4 in FIG. 7(A) shows an entirety of the image data. In the above, a part defined by P1 and P3 denotes a header. A part defined by P2 and P3 in the header is additional data which is to be rewritten according to the aforementioned releasable range (condition for uploading).

Upon performing the processing, the processing unit 170 analyzes the header (the part defined by P1 and P3 in FIG. 7(A)) of the image data which is not yet processed, and extracts the additional data (the part defined by P2 and P3 in FIG. 7(A)).

In the embodiment, as described later, though the additional data is defined as to be formed in a format approximately equivalent to EXIF configuration, the additional data may be formed in a unique format other than the EXIF.

The processing unit 170 performs processing on the extracted additional data. Specifically, the processing unit 170 generates rewritten data (a part defined by P5 and P6 in FIG. 7(B)) in which information contained in the additional data was arbitrarily rewritten. Even if any rewriting is performed, the processing unit 170 generates the rewritten data having the data amount which is the same with that of the additional data.

Accordingly, data as it is can be used without any change in the part defined by P1 and P2 and the part defined by P3 and P4 in FIG. 7(A) of original image data. In other words, the processed image data can be generated in a device where the image data is uploaded only by reading out the rewritten data instead of the additional data, when the data is readout at the time of uploading the image data.

Here, steps for rewriting data without changing the data amount are described, using a case, as an example, where the additional data is formed in the format same with the EXIF format.

First, an example of data in the EXIF format is described.

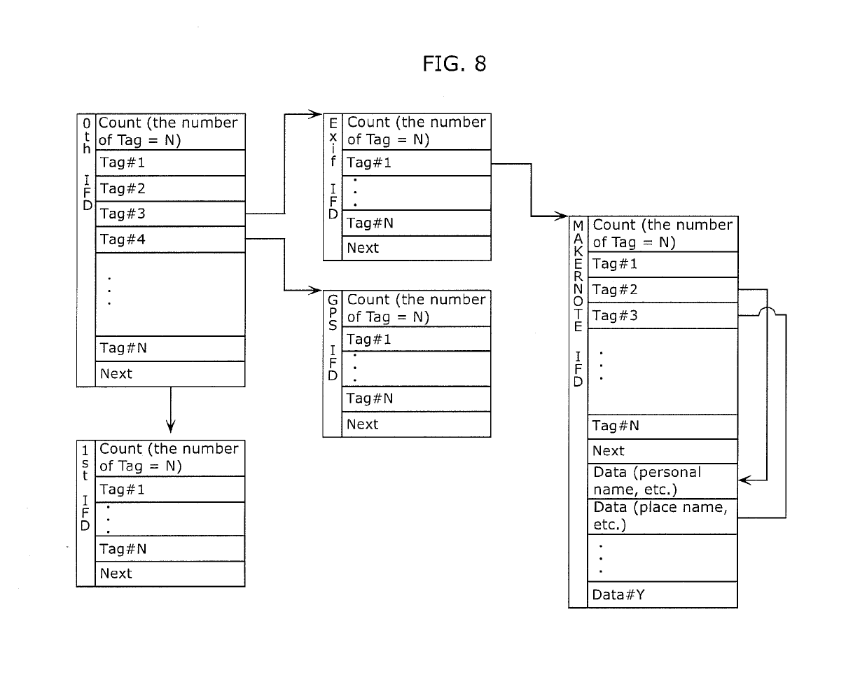

FIG. 8 is a conceptual diagram that shows an example of additional data in the EXIF format.

As shown in FIG. 8, the additional data (header) of the image data in the EXIF format includes a plurality of image file directories (IFD). In an example shown in FIG. 8, the header has a configuration in which 0th IFD, 1st IFD, Exif IFD, GPS IFD, and MAKERNOTE IFD continue with one another.

Each of the IFDs contains a plurality of Tags each of which stores information. For example, Tag#3 in the 0th IFD in FIG. 8 stores address information for accessing to the Exif IFD. Similarly, Tag#4 in 0th IFD stores address information for accessing to the GPS IFD. Furthermore, Tag#1 in the Exif IFD stores address information for accessing to the MAKERNOTE IFD.

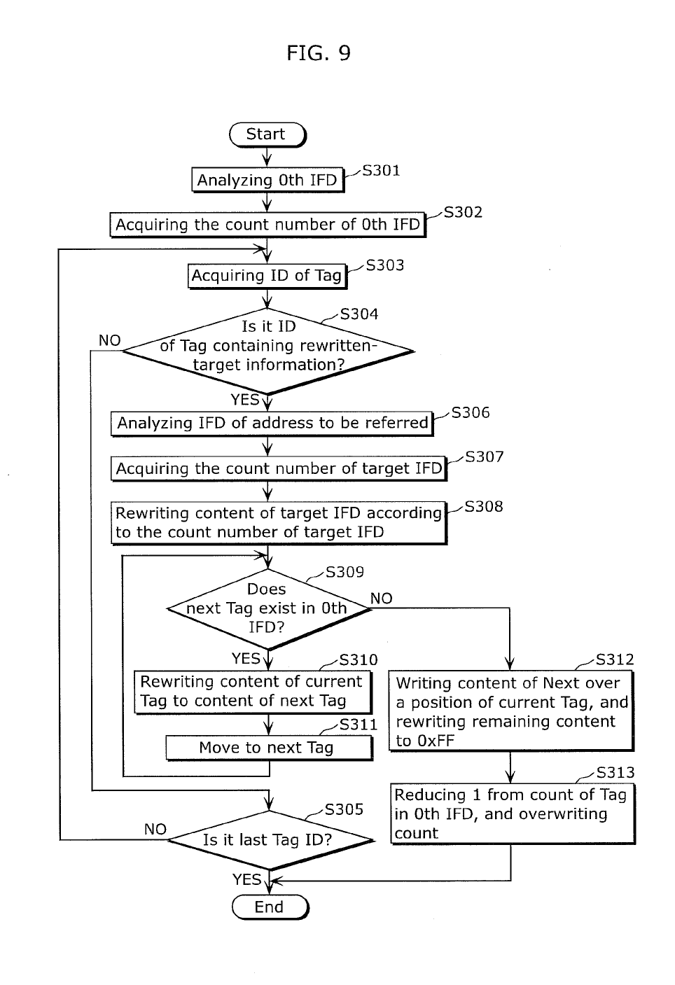

Next, description is given to a method for performing the processing on the data in the EXIF format shown in FIG. 8, and generating the rewritten data. To be specific, a method for rewriting, to 0xFF, a content of the GPS IFD which exists in an address to be referred by the Tag#4 in the 0th IFD in FIG. 8 is described, with reference to FIG. 8 and FIG. 9.

FIG. 9 is a flowchart that shows an operation of rewriting information of a specified IFD in the EXIF format to invalid data.

First, the processing unit 170 performs analysis on the 0th IFD that is the first IFD (Step S301 in FIG. 9), and acquires the number a count (count number) of the 0th IFD (Step S302 in FIG. 9). The count number indicates the number of Tags in the directory (in this case, 0th IFD).

Subsequently, the processing unit 170 acquires identification data (ID) of the first Tag included in the 0th IFD (Step S303 in FIG. 9). When the Tag having the acquired ID is a Tag which contains rewritten-target information (specified personal information, such as GPS location information and a personal name) (Yes in Step S304 In FIG. 9), the processing unit 170 performs rewriting on the Tag, as indicated in Steps S306 to S313 in FIG. 9.

In the example shown in FIG. 8, the Tag#4 contains the rewritten-target information, so that the rewriting processing is performed on the Tag#4 shown in Steps S306 to S313.

On the other hand, the ID acquired in Step S303 is an ID of a Tag which does not contain the rewritten-target information (No in Step S304 in FIG. 9), the processing unit 170 determines whether or not the ID of the acquired Tag is the ID of the last Tag included in 0th IFD (Step S305 in FIG. 9). If the ID of the acquired Tag is the ID of the last Tag (Yes in Step S305 in FIG. 9), the processing unit 170 terminates the processing, while if not (No in Step S305 in FIG. 9), the processing is returned back to Step S303.

Next, the rewriting processing on a Tag (Steps S306 to Step S313) is described in detail.

When the Tag having the ID acquired in Step S304 contains rewritten-target information (Yes in Step S304 in FIG. 9), the processing unit 170 performs analysis on an IFD (target IFD) which exists in a reference address indicated in the address information stored in the Tag (Step S306 in FIG. 9), and acquires the count number of the target IFD (Step S307 in FIG. 9).

In the example shown in FIG. 8, the processing unit 170 acquires N which is the count number of the GPS IFD.

The processing unit 170 rewrites a content of the target IFD to 0xFF that indicates an invalid value, according to the count number acquired in the Step S307 (Step S308 in FIG. 9). In other words, the processing unit 170 fills the content of the target IFD with 0xFF that indicates the invalid value.

In the example shown in FIG. 8, since the GPS location information which is to be rewritten is stored in the Tag#4, the processing unit 170 rewrites, to 0xFF, the content of the GPS IFD which exists in the reference address, according to the count number N.

When a Tag next to the currently referred Tag exists (Yes in Step S309 in FIG. 9), the processing unit 170 rewrites the content of the currently referred Tag to a content of the next Tag (Step S310 in FIG. 9), moves a referred address from the current Tag to an address of the next Tag (Step S311 in FIG. 9), and returns the processing back to the processing in Step S309.

In the example shown in FIG. 8, the processing unit 170 rewrites the content of the Tag#4 to a content of Tag#5, and subsequently moves the referred address from the current Tag to the address of the Tag#5, and finally returns the processing back to the processing shown in Step S309.

If the Tag next to the currently referred Tag does not exist in Step S309 (No in Step S309 in FIG. 9), the processing unit 170 writes a content stated in a Next part over the position of the currently referred Tag, and also rewrites a remaining Tag in the target IFD to 0xFF that indicates the invalid value (Step S312 in FIG. 9).

In the example shown in FIG. 8, no next Tag exists if the Tag#N is referred. Accordingly, the processing unit 170 writes the content stated in the Next part over a position of the Tag#N, and also rewrites the remaining Tags to 0xFF that indicates the invalid value.

The processing unit 170 reduces 1 from a value stated in a count part in 0th IFD (Step S313 in FIG. 9), and terminates the rewriting process. If a plurality of IFDs to be removed exist, the processing unit 170 may execute routine processes in the flowchart shown in FIG. 9 as many times as the number of the IFD to be removed.

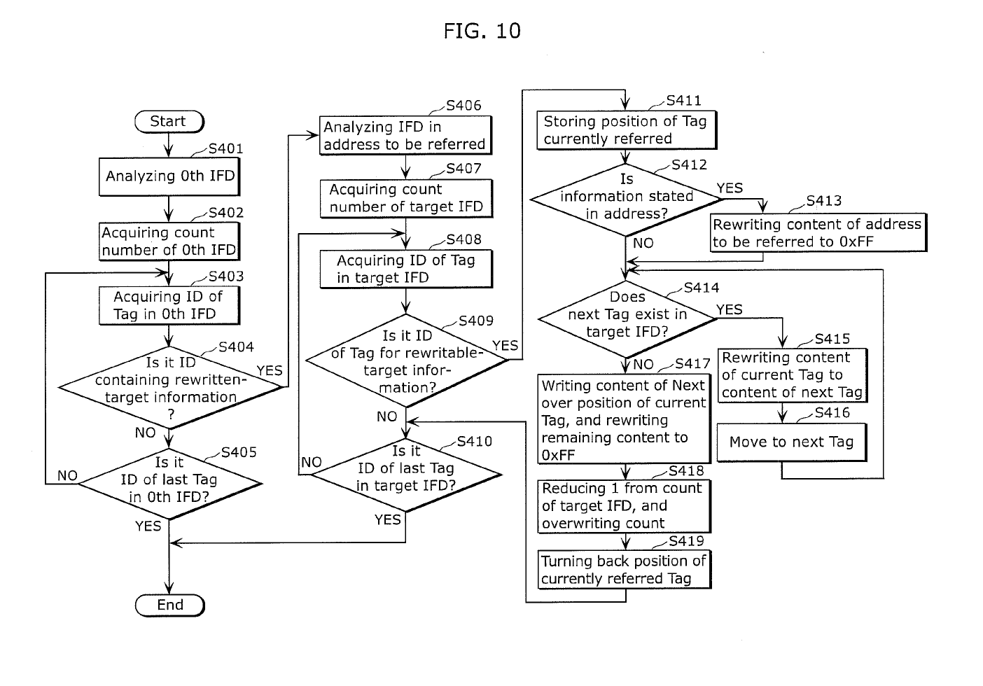

Subsequently, an example is described in which information of the specified Tag included in a specified IFD is rewritten to an invalid data. To be specific, description is given, with reference to FIGS. 8 and 10, to a method for rewriting, to 0xff, information (a personal name, a location name, and so on) in the MARKERNOTEIFD placed in a lower layer than the Exif IFD placed in the address to be referred by the Tag#3 in the 0th IFD in FIG. 8.

FIG. 10 is a flowchart that shows an operation of rewriting information in a specified Tag included in a specified IFD in the EXIF format.

The processing unit 170 performs analysis on the 0th IFD that is the first IFD (Step S401 in FIG. 10), and acquires the count number of the 0th IFD (Step S402 in FIG. 10).

Subsequently, the processing unit 170 acquires the ID of the first Tag included in the 0th IFD (Step S403 in FIG. 10). When the rewritten-target information exists in the Tag having the acquired ID (Yes in Step 404 in FIG. 10), the processing unit 170 performs, on the Tag, rewriting processing indicated in Steps S406 to S419.

On the other hand, if the acquired ID is an ID of a Tag which does not contain rewritten-target information (No in Step S404 in FIG. 10), the processing unit 170 determines whether or not the acquired ID of the Tag is the ID of the last Tag included in the 0th IFD (Step S405 in FIG. 10). If the acquired ID is the ID of the last Tag (Yes in Step S405 in FIG. 10), the processing unit 170 terminates the processing, while if not (No in Step S405 in FIG. 10), the processing unit 170 returns the processing back to the processing in step S403.

If the Tag to be rewritten is included in an IFD in a further lower layer, the processes in Steps S401 to S403 may be executed as many times as the number of the layers of the IFD, in the same manner as above.

In the example shown in FIG. 8, as a result of the processes in Step S401 to S403 that have been executed twice, it is determined in Step S404 that the Tag#1 included in EXIFIFD is the ID of the Tag containing the rewritten-target information. Accordingly, the rewriting processes (Steps S406 to S419) are performed on the Tag#1 included in EXIFIFD.

Next, processing of rewriting a Tag (Steps S406 to S419) is described in detail.

If the Tag having the acquired ID contains rewritten-target information in Step S404 (Yes in Step S404 in FIG. 10), the processing unit 170 performs analysis on the IFD (target IFD) which exists in the referred address indicated by the address information stored in the Tag (Step S406 in FIG. 10), and acquires the count number of the target IFD (Step S407 in FIG. 10).

In the example in FIG. 8, since the target IFD is MAKERNOTE IFD, the processing unit 170 acquires the count number of the MAKERNOTE IFD.

Subsequently, the processing unit 170 acquires the ID of the Tag in the target IFD (Step S408 in FIG. 10), and performs the rewriting processes (steps S411 to S419) on the Tag if the acquired ID is the ID of the Tag containing the rewritten-target information (Yes in Step S409 in FIG. 10).

If the acquired ID is not the ID of the Tag to be rewritten (No in Step S409 in FIG. 10), and the acquired ID is the ID of the last Tag included in the target IFD (Yes in Step S410 in FIG. 10), the processing unit 170 terminates the processing.

If the acquired ID is not the ID of the last Tag included in the target IFD (No in Step S410 in FIG. 10), the processing unit 170 returns the processing back to the processing in Step S408.

If the rewritten-target information is contained in the Tag having the ID acquired in Step S408 (Yes in Step S409 in FIG. 10), the processing unit 170 temporarily stores a position of the currently-referred Tag in the working memory 252.

In the example shown in FIG. 8, since the Tag#2 in the MAKERNOTE IFD contains the rewritten-target information, the processing unit 170 temporarily stores the position of the Tag#2 in the MAKERNOTE IFD in the working memory 252.

If the information stored in the Tag in the IFD (reference IFD) which is referred by the Tag having the ID acquired in the Step S408 is the information stated in the address (Yes in Step S412 in FIG. 10), all contents stored in the referred address is rewritten to 0xFF (Step S413 in FIG. 10).

In the example shown in FIG. 8, the information stated in the address is stored in the Tag#2 in the MAKERNOTE IFD that is the reference IFD. Accordingly, the processing unit 170 rewrites, to 0xFF, the content (a personal name, and so on) stored in Data that is the address to be referred.

If a Tag next to the currently-referred Tag exists (Yes in Step S414 in FIG. 10), the processing unit 170 rewrites the content of the currently referred Tag to a content of the next Tag (Step S415 in FIG. 10), moves the referred position from the current Tag to the next Tag (Step S416 in FIG. 10), and returns the processing back to the processing in Step S414.

In the example shown in FIG. 8, the processing unit 170 rewrites the content of the Tag#2 to the content of Tag#3, and subsequently moves the referred position from the current Tag to the Tag#3, and finally returns the processing back to the processing shown in Step S309.

If the Tag next to the currently referred Tag does not exist in Step S414 (No in Step S414 in FIG. 10), the processing unit 170 writes a content stated in the Next part over the position of the currently referred Tag, and also rewrites the remaining Tags in the target IFD to 0xFF that indicates the invalid value (Step S417 in FIG. 10).

In the example shown in FIG. 8, no next Tag exists when the Tag#N in the MAKERNOTE IFD is referred. Accordingly, the processing unit 170 writes the content stated in the Next part to a position of the Tag#N, and also rewrites the remaining Tags in the MAKERNOTE IFD to 0xFF that indicates the invalid value.

The processing unit 170 performs the processing in Step S410 by reducing 1 from a value described in the count part of the target IFD (Step S418 in FIG. 10), and returning the position of the currently referred Tag to the position which was stored in Step S411 (Step S419 in FIG. 10).

In the example shown in FIG. 8, the rewriting processing on the Tag#2 in the MAKERNOTE IFD terminates at this point. Here, the Tag#3 in the MAKERNOTE IFD contains the rewritten-target information. Accordingly, the processing unit 170 performs the processes in Steps S411 and S412 on the Tag#3 in the MAKERNOTE IFD. With this, the content (a place name and the like) stored in Data that is an address to be referred to by the Tag#3 in the MAKERNOTE IFD serving as the reference IFD is rewritten to 0xFF.

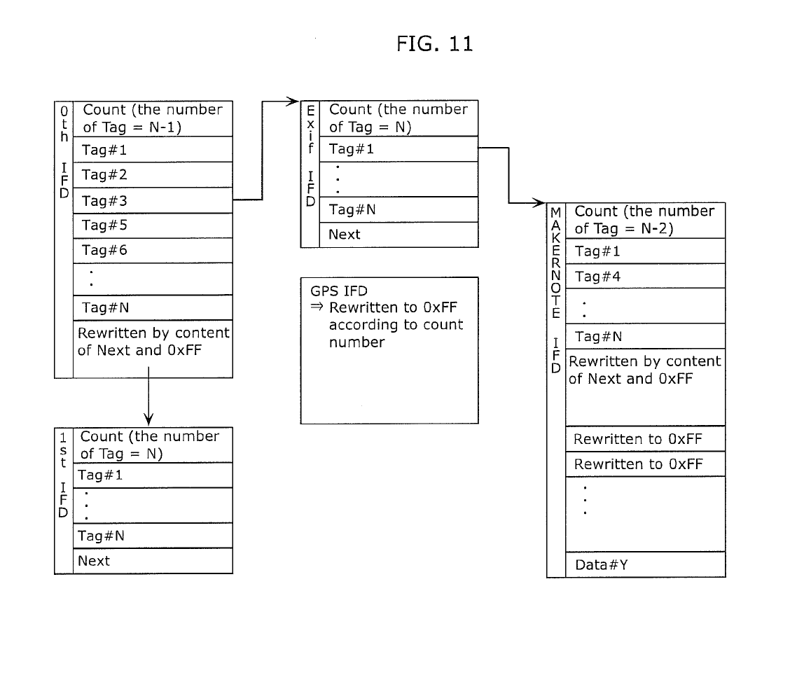

FIG. 11 is a conceptual diagram that shows a data configuration of the rewritten data to which the processing described referring to FIGS. 8, 9, and 10 has been performed.

As shown in FIG. 11, all contents of the GPS IFD indicated by the address information stored in the Tag#4 in 0th IFD are rewritten to 0xFF by the processes shown in the flowchart of FIG. 9. The Tag#4 in the 0th IFD is overwritten by the Tag#5 which is the next Tag of the Tag#4. The overwriting processing is also performed on the subsequent Tags, and a last part of the 0th IFD is rewritten by the content of the Next and 0xFF.

Furthermore, as shown in FIG. 11, the specified personal information (a name of a person and a name of a place in the example in FIG. 8) in the MAKERNOTE IFD is rewritten by 0xFF that is the data indicating an invalid value, in operation steps in the flowchart of FIG. 10.

Specifically, the Tag#2 and Tag#3 in the MAKERNOTE IFD are overwritten. The last part of the MAKERNOTE IFD is rewritten by the content of the Next and 0xFF. Data regions indicated by the address information stored in the respective Tag#2 and Tag#3 are also rewritten by 0xFF.

In the aforementioned rewriting processing on the image data in the EXIF format, the processing unit 170 previously figures out the count number in each of the IFDs in the Exif format, and the data amount for each of Tags. Accordingly, the processing unit 170 can rewrite the content of the IFD by 0xFF and the like based on a predetermined data amount for each of Tags, so that no contradiction occurs due to reduction of the count number upon overwriting and moving on the Tag. Accordingly, the data amount does not change between before and after the rewriting processing, i.e., between the additional data and the rewritten data.

The processing unit 170 may rewrite only a content of Tag without performing other processing on the Tag, such as overwriting the Tag. In other words, the processing unit may generate the rewritten data in a data configuration which is the same with a data configuration of the additional data. In this case, the number of the Tags in the IDF does not change, so that the rewriting processing can be more easily performed.

The processing unit 170 may rewrite the content of the Tag to a predetermined value instead to 0xFF indicating a invalid value. For example, the processing unit 170 may rewrite the personal information that should be processed to information in a broader concept of the personal information. Specifically, if a name of city is stored as information of a place name in the additional data, the city name may be rewritten to a name of a country to which the city belongs. The processing for rewriting the city name to the country name can be achieved based on the GPS location information in the image data. In addition, the personal information in relation to names, such as a name of a person who shot the image, a name of an object, a name of a place where the image is shot, may be rewritten to the information in which names are indicated in initial, and information in relation to “year, month, day, and time” when the image is shot is rewritten to information of only “year and month”.

As such, if the personal information is rewritten to the broader concept thereof, advantages are brought that the details of the information is prevented from being leaked and at the same time, abstract information in relation to the image data can be obtained.

If the content of the Tag is rewritten to a predetermined value instead to 0xFF that indicates an invalid value, it is necessary to rewrite the content to information having the data amount smaller than that the information prior to be rewritten has. In other words, it is necessary to perform the rewriting processing insofar as the additional data and the rewritten data can be equalized in the data amount.

[1-5 Advantageous Effects]

As described above, the PC 250 according to the embodiment generates the rewritten data resulting from rewriting a part of the additional data included in the image data. The generated rewritten data has the data amount which is the same with that of the additional data. The PC 250 loads the rewritten data instead of the additional data in loading processing when the image data is uploaded on the server 300, and generates the processed image data in the server 300 on which the image data is to be uploaded.

Since the processed data except the additional data is totally equal to the data which is not processed, the image does not deteriorate due to re-encoding processing. Even if the loading processing is performed on the rewritten data instead of the additional data so as to upload the loaded data, a time period required for uploading the image data is approximately the same with that in the additional data. Particularly in a case of uploading a video, rewriting only a part of the data, not whole data, is very efficient because the total data amount of the video is larger than that of a still image.

According to the PC 250, if the personal information in the image data should be rewritten according to the releasable range of the image data, the image data in the image-sharing service 100 can be released without carelessly leaving the personal information in the released data.

### Other Embodiments

The embodiment has been described as an example of technique disclosed in the present application. However, the technique in the present disclosure is not limited to the above, but is applicable to an embodiment to which modification, replacement, addition, omission, and the like are appropriately performed. It is also possible to create a new embodiment by combining structural components described in the above embodiment.

In the above embodiment, though it is determined whether or not the image data is processed according to the condition in relation to a releasable range in the image-sharing service 100, the present disclosure is not limited to such a configuration. For example, when image data is copied in a local PC or a shared folder in a computer on a network, it may be determined whether or not the image is processed according to the shared condition for the folder. In other words, processing of generating the rewritten data may not be performed at uploading the image data, but may be previously performed, and the rewritten data may be stored in a storage unit in a PC.

Furthermore, it may be determined whether or not the image data is processed based on a condition in relation to time and date (generation time and date) when the image is shot. To be specific, if time and date when the image was shot is prior to a predetermined time and date, the image data may not be processed, while time and date when the image was shot is after the predetermined time and date, the image data may be processed, for example.

Furthermore, the number of information items (processing-target information) to which the rewriting is performed according to the releasable range may change. For example, the broader the releasable range is, the more the number of information items to which the rewriting is performed. In this case, the content and the number of the information items to which the rewriting is performed are previously associated with the releasable range.

In addition, if the image data is copied to a media, such as a digital versatile disc (DVD) or a Blu-ray disc, to which the releasable range cannot be set, the image data is processed without fail. Such configuration is included in a scope to which the present disclosure is applicable.

In the above embodiment, final determination on whether or not the data is released is performed after processing of confirmation is performed to a user. However, if the user previously configures setting on the releasing of the data, the user-confirming processing can be omitted. The number of the information items to be rewritten and how the data is rewritten (rewriting the data to data indicating invalidity or to a broader concept) may be arbitrarily settable by a user.

In the embodiment, a temporary storage place of the rewritten data is the HDD 253. However, the rewritten data is temporarily stored data. Accordingly, the rewritten data may be temporarily stored in the working memory 252 as long as the data amount of the rewritten data is acceptable for the working memory 252. The rewritten data may temporarily be stored in the memory card 140 via the card slot 261.

In the embodiment, though a case in which the present disclosure is applied to the personal computer 250 is described, the application of the present disclosure is not limited to the PC. As long as a device includes a controller, a working memory, a storing range, such as an HDD, and a communication unit, that are counterparts of those in the PC 250, the present disclosure can be applied even to the device, such as a smartphone, and a cellular phone.

For example, the present disclosure may be applied to the server 300. In this case, the controller 302 in the server 300 acquires image data from the PC 250 placed outside, rewrites the additional data in the image data to the rewritten data, so as to generate the processed image data, and stores the generated data in the storage unit 304.

The present disclosure includes an electronic device having a configuration based on the concept of the present disclosure, a program executed by a computer in the electronic device, a recording medium storing the program, and a series of operational steps based on the concept of the present disclosure.

In the present embodiment, the image data means a video. However, the image data is not limited to the video, but may be a still picture, for example. If the still picture is in the JPEG format, information in the EXIF format is rewritable by applying steps same with those in the embodiment of the present disclosure.

The configuration of the image data is not limited to the EXIF format, but may be in another format. In this case, as long as a rewritable part is an independent information block and can be generated without changing a data amount between before and after the rewriting of the information, the steps described in the embodiment can be applied as they are.

In addition, the present disclosure includes the following cases, for example.

(1) A part or all of components constituting the aforementioned respective devices may be formed, specifically, as a computer system including a microprocessor, a ROM, a RAM, a hard disc unit, a display unit, a keyboard, a mouse, and so on. A computer program is stored in the RAM or the hard disc unit. The microprocessor operates in accordance with the computer program, so that each of the devices accomplishes its function. Here, the computer program is, for accomplishing a predetermined function, configured by combining a plurality of instruction codes indicating instructions for a computer.

(2) A part or all of the components constituting each of the above devices may be formed by a single System-LSI (Large-Sale Integration) circuit. The System LSI is a super multifunction LSI manufactured by integrating a plurality of constituent units on a single chip, and is, specifically, a computer system including a microprocessor, a ROM, a RAM, and so on. In the ROM, a computer program is stored. The microprocessor loads the computer program from the ROM to the RAM, and operates in accordance with the loaded computer program, so that the System-LSI accomplishes its function.

(3) A part or all of the components constituting each of the devices may be formed as an IC card which is detachable from each of the devices or a single module. The IC card or the module is a computer system including a microprocessor, a ROM, a RAM, and so on. The IC card or the module may include the super multifunction LSI. The microprocessor operates in accordance with the computer program, so that the IC card or the module accomplishes its function. The IC card or the module may have tamper resistance.

(4) The present disclosure may be in the form of the method described above. In addition, the present invention may be a computer program which realizes the method by a computer, or may be digital signals including the computer program.

The present disclosure may also be achieved by storing the computer program or the digital signals in a computer readable recording medium, such as a flexible disc, a hard disc, a CD-ROM, an MO, a DVD, a DVD-ROM, a DVD-RAM, a Blue-ray disc (BD), a semiconductor memory, and so on. Alternatively, the present disclosure may also be realized by the digital signals recorded in these recording media.

The present disclosure may also be achieved by transmission of the aforementioned computer program or digital signals via an electric telecommunication line, a wireless or wired communication line, a network represented by the Internet, a data broadcast, and so on.

The present invention may also be a computer system including a microprocessor and a memory, in which the memory stores the aforementioned computer program, and the microprocessor may operate in accordance with the computer program.

Furthermore, the program or the digital signals may be stored in the recording medium so as to be transferred, or the program or the digital signals may be transferred via the network or the like so as to be executed by another independent computer system.

(5) The above embodiments and modifications may be combined arbitrarily.

As described heretofore, an embodiment is described as an example of technique disclosed in the present disclosure. For the disclosure, the attached drawings and the detailed description are provided.

Accordingly, structural components illustrated in the attached drawings and described in the detailed disclosure may include not only necessary structural components but also unnecessary structural components for solving the problems, in order to exemplify the above technique. Therefore, the illustration or description of these unnecessary structural components in the attached drawings and the detailed description should not lead immediate recognition on the necessity of the unnecessary structural components.

The above described embodiments should be referred to as an example of the technique of the present disclosure. Accordingly, various modification, replacement, addition, omission, and the like can be performed within a range of the scope of the claims and the equivalents thereof.

Although only an exemplary embodiment of the present invention has been described in detail above, those skilled in the art will readily appreciate that many modifications are possible in the exemplary embodiment without materially departing from the novel teachings and advantages of the present invention. Accordingly, all such modifications are intended to be included within the scope of the present disclosure.

### INDUSTRIAL APPLICABILITY

The present disclosure is usable as a PC and the like, which is capable of rewriting the personal information and uploading the rewritten information in a content-sharing service.

1. A content data processing apparatus that performs processing on a content data including an additional data, the content data processing apparatus comprising:
a processor that:
(i) acquires the content data;
(ii) extracts the additional data included in the acquired content data, rewrites a processing-target information which is at least a part of predetermined personal information contained in the additional data, and generates, from the additional data, a rewritten data having a data amount which is the same with a data amount of the additional data, the predetermined personal information being defined based on a predetermined condition; and
(iii) generates a processed content data in which the additional data included in the content data is rewritten to the rewritten data.

2. The content data processing apparatus according to claim 1,
wherein the processor generates the rewritten data having a data configuration which is the same with a data configuration of the additional data.

3. The content data processing apparatus according to claim 1,
wherein the processing-target information includes at least one of (i) information indicating a location where an image of the content data was shot, (ii) information indicating year, month, and day when the image of the content data was shot, (iii) information indicating a person who shot the image of the content data, and (iv) information indicating an object to be reconstructed from the content data.

4. The content data processing apparatus according to claim 1,
wherein the predetermined condition is a condition for a releasable range of the content data, or a condition for time and date when the content data is generated.

5. The content data processing apparatus according to claim 1,
wherein the processor rewrites the processing-target information to information indicating an invalid value having a data amount which is the same with a data amount of the processing-target information, and generates the rewritten data having the data amount which is the same with the data amount of the additional data.

6. The content data processing apparatus according to claim 1,
wherein the processor
(i) rewrites the processing-target information to information in a broader concept of the processing-target information, the broader-concept information having a data amount which is the same with a data amount of the processing-target information, and
(ii) generates the rewritten data having the data amount which is the same with the data amount of the additional data.

7. The content data processing apparatus according to claim 1,
wherein the processor further reads out the content data to upload the read-out content data on a storage device provided outside the content data processing apparatus, and performs controlling to read out the rewritten data instead of the additional data when the content data is uploaded, thereby generating the processed content data in the storage device.

8. The content data processing apparatus according to claim 7,
wherein the processing is performed when the processor uploads the content data.

9. The content data processing apparatus according to claim 1, further comprising
a storage unit,
wherein the processor
(i) acquires the content data from a device provided outside the content data processing apparatus, and
(ii) rewrites the additional data included in the content data to the rewritten data, generates the processed content data, and stores the generated data in the storage unit.

10. The content data processing apparatus according to claim 1,
wherein the content data is exchangeable image file format (EXIF) data, and
the additional data is a part of the EXIF data, in which metadata is recorded.

11. A method for processing a content data including an additional data, the method comprising:
acquiring the content data;
extracting the additional data included in the content data acquired in the acquiring, rewriting a processing-target information which is at least a part of predetermined personal information contained in the additional data, and generating, from the additional data, a rewritten data having a data amount which is the same with a data amount of the additional data, the predetermined personal information being defined based on a predetermined condition; and
generating a processed content data in which the additional data included in the content data is rewritten to the rewritten data.
